(19) United States
(12) Patent Application Publication
(10) Pub. No.: US 2024/0243587 A1
(43) Pub. Date: Jul. 18, 2024

(54) A SYSTEM COMPRISING ENERGY STORAGE UNITS AND METHOD IN SUCH A SYSTEM

(71) Applicant: Hitachi Energy Ltd, Zürich (CH)

(72) Inventors: Lexuan MENG, Västerås (SE); Mohsen ASOODAR, Solna (SE); Tong WU, Västerås (SE); Mikael TENERZ, Västerås (SE); Hongyang ZHANG, Stockholm (SE)

(21) Appl. No.: 18/563,819

(22) PCT Filed: May 25, 2021
(86) PCT No.: PCT/EP2021/063919

§ 371 Date: Nov. 22, 2023

(51) Int. Cl. H02J 7/00; H02J 7/34

(52) U.S. Cl. CPC H02J 7/0016; H02J 7/007182; H02J 7/345; H02J 2207/50

(57) ABSTRACT

A system is disclosed, comprising a plurality of energy storage units and at least one voltage balancing unit. Each voltage balancing unit is associated with at least one of the energy storage units. The at least one voltage balancing unit is connected to the energy storage units and when activated is configured to, on a condition that the voltage of at least one of the energy storage units associated with the at least one voltage balancing unit exceeds a threshold voltage level, reduce the voltage of at least the one(s) of the energy storage units whose voltage exceeds the threshold voltage level so as to become equal to or smaller than the threshold voltage level. The system comprises at least one control and/or processing unit configured to, if the at least one voltage balancing unit is activated and the voltage of at least one of the energy storage unit(s) associated with the at least one voltage balancing unit exceeds the threshold voltage level, monitor an amount of time during which the at least one voltage balancing unit is or has been activated.

### TECHNICAL FIELD

The present invention relates to a system comprising energy storage units such as capacitors, and a method in such a system.

### BACKGROUND

Electrical parameters of an electrical energy storage unit, such as the equivalent series resistance (ESR) and capacity (e.g., energy rating), may vary significantly from beginning of life of the electrical energy storage unit to the end of life of the electrical energy storage unit. The electrical energy storage unit may for example comprise or consist of one or more batteries or ultracapacitors.

In applications in which a large number of electrical energy storage units may be used, such as, for example, in power transfer, distribution and generation applications, it is useful to have indications of lifetime or state-of-health (SOH) of the electrical energy storage units to know when there is a need for replacing electrical energy storage units due to aging of them, and also to know which electrical energy storage units that need to be replaced.

SOH of an electrical energy storage unit can often be estimated either by offline measurement of ESR and capacity of the electrical energy storage unit or based on a model of the aging (or lifetime) of the electrical energy storage unit using historical data of the electrical energy storage unit (e.g., historical data on voltage, temperature, etc. of the electrical energy storage unit). Offline measurements are carried out during outage of the apparatus, system, etc. in which the electrical energy storage units are included. If there is a large number of electrical energy storage units, the offline measurements may require a significant amount of time, during which the apparatus, system, etc. in which the electrical energy storage units are included is offline. The accuracy of an estimation of SOH of an electrical energy storage unit based on a model of the aging or lifetime of the electrical energy storage unit may be strongly dependent on the accuracy of the model that is used. Relatively time-consuming computations and a relatively large data storage may also be needed. Either of these ways of estimating SOH of an electrical energy storage unit may not be very efficient in large scale electrical energy storage applications, which may require estimation of SOH of a very large number of electrical energy storage units.

### SUMMARY

In view of the foregoing, a concern of the present invention is to provide means that allow or facilitate for relatively easily providing an indication of which energy storage units of a plurality of energy storage units that due to aging thereof require maintenance or replacement.

To address at least one of this concern and other concerns, a system and a method in a system in accordance with the independent claims are provided. Preferred embodiments are defined by the dependent claims.

According to a first aspect of the present invention, a system is provided. The system may comprise a plurality of energy storage units. Each energy storage unit may be capable of selectively being charged with electrical energy supplied to the energy storage unit and to discharge electrical energy stored in the energy storage unit. Each energy storage unit may be associated with a threshold voltage level. The system may comprise at least one sensing unit, which may be configured to sense (e.g., at least) a voltage of each of the energy storage units. The system may comprise at least one voltage balancing unit. Each voltage balancing unit may be associated with at least one of the energy storage units. The at least one voltage balancing unit may be connected to the energy storage units. When activated, the at least one voltage balancing unit may be configured to, on a condition that the voltage of at least one of the energy storage units associated with the at least one voltage balancing unit exceeds the threshold voltage level, reduce the voltage of at least the one(s) of the energy storage units whose voltage exceeds the threshold voltage level so as to become equal to or smaller than the threshold voltage level. The system may comprise at least one control and/or processing unit. The at least one control and/or processing unit may be configured to, if the at least one voltage balancing unit is activated and the voltage of at least one of the energy storage unit(s) associated with the at least one voltage balancing unit exceeds the threshold voltage level, monitor an amount of time during which the at least one voltage balancing unit is or has been activated.

According to a second aspect of the present invention, a method in a system is provided. The system may comprise a plurality of energy storage units. Each energy storage unit may be capable of selectively being charged with electrical energy supplied to the energy storage unit and to discharge electrical energy stored in the energy storage unit. Each energy storage unit may be associated with a threshold voltage level. The system may comprise at least one voltage balancing unit. Each voltage balancing unit may be associated with at least one of the energy storage units. The at least one voltage balancing unit may be connected to the energy storage units. The at least one voltage balancing unit may when activated be configured to, on a condition that the voltage of at least one of the energy storage units associated with the at least one voltage balancing unit exceeds the threshold voltage level, reduce the voltage of at least the one(s) of the energy storage units whose voltage exceeds the threshold voltage level so as to become equal to or smaller than the threshold voltage level.

The method according to the second aspect of the present invention may comprise, if the at least one voltage balancing unit is activated and the voltage of at least one of the energy storage unit(s) associated with the at least one voltage balancing unit exceeds the threshold voltage level, monitoring an amount of time during which the at least one voltage balancing unit is or has been activated.

For each or any voltage balancing unit, an indication (e.g., a signal) that the at least one of the energy storage units with which the voltage balancing unit is associated requires maintenance or replacement may be provided (e.g., generated) based at least on the amount of time during which the voltage balancing unit has been activated. For example, the at least one control and/or processing unit may be configured to, for each or any voltage balancing unit, determine that the amount of time during which the voltage balancing unit has been activated exceeds a threshold amount of time, and provide the indication based at least on the determination. According to another example, the at least one control and/or processing unit may, in alternative or in addition, be configured to, for each or any voltage balancing unit, compare the amount of time during which the voltage balancing unit has been activated with the amount of time during which at least one of the other voltage balancing units has been activated, and provide the indication based at least on the comparison. Thus, the indication may be provided for a voltage balancing unit based on a comparison of the relative operating or activation time thereof as compared to other voltage balancing unit(s). Such a comparison may be carried out repeatedly, e.g., continuously.

According to another example, the at least one control and/or processing unit may, in alternative or in addition, be configured to, for each or any voltage balancing unit, determine a difference between the amount of time during which the voltage balancing unit has been activated and the amount of time during which at least one of the other voltage balancing units has been activated, and determine whether the difference exceeds a threshold difference. The indication may be provided based on the determination whether the difference exceeds the threshold difference. Thus, the indication may be provided for a voltage balancing unit based on any drift between the amount of time during which the voltage balancing unit has been activated and the amount of time during which at least one of the other voltage balancing units has been activated. The threshold difference may for example be defined in terms of a multiple of the amount of time during which at least one of the other voltage balancing units has been activated. The threshold difference might for example be two times, or three times or more, the amount of time during which at least one of the other voltage balancing units has been activated. For example, if it is determined that the amount of time during which a voltage balancing unit has been activated is equal to or more than X times the amount of time during which at least one of the other voltage balancing units has been activated (with X being >1, such as 2 or 3), an indication that the at least one of the energy storage unit with which the voltage balancing unit is associated requires maintenance or replacement may be provided. The operations of (for each or any voltage balancing unit) determining a difference between the amount of time during which the voltage balancing unit has been activated and the amount of time during which at least one of the other voltage balancing units has been activated, determining whether the difference exceeds a threshold difference, and providing the indication based on the determination whether the difference exceeds the threshold difference may be carried out repeatedly, e.g., continuously.

Thus, embodiments of the present invention may facilitate or allow for relatively easily providing an indication of which energy storage unit(s) in the system that due to aging require maintenance or replacement, by means of monitoring usage of the at least one voltage balancing unit.

The at least one control and/or processing unit may be configured to monitor an amount of time during which the at least one voltage balancing unit is or has been activated for example by integrating or summing the amount of time during which the at least one voltage balancing unit is or has been activated. The time during which the at least one voltage balancing unit is or has been activated may be referred to as a switch-on time due overvoltage of at least one of the energy storage unit(s) associated with the at least one voltage balancing unit. The switch-on time of the at least one voltage balancing unit may be taken as an indication of SOH of the at least one of the energy storage units with which the voltage balancing unit is associated in relation to other energy storage units.

By means of monitoring usage of the at least one voltage balancing unit as per the above-mentioned first and second aspects of the present invention, an indication of which energy storage unit(s) in the system that require maintenance or replacement and possibly an indication of state of health of the energy storage units can be provided without or with less need for (offline) measurements of ESR and capacity (e.g., capacitance) of the energy storage units, and without or with less need for complicated models model for the aging or lifetime of the energy storage units.

For a system with a large number of energy storage units, it is useful to be able to obtain an indication of which energy storage unit(s) in the system that require maintenance or replacement and possibly an indication of SOH of the energy storage units in order to keep down maintenance costs, maintain system energy rating and ensure safe operation of the system.

The threshold amount of time may for example be a fixed period of time (e.g., a fixed number of hours) that has been established by means of experiments and/or simulations for investigating aging of the energy storage unit (e.g., the type(s) of energy storage unit used in the system). The threshold amount of time may however not be fixed (e.g., may not be a fixed period of time). According to another example, the threshold amount of time may be a relative difference between a longest period of time during which a voltage balancing unit has been activated (e.g., which has been monitored) and a shortest period of time during which a voltage balancing unit has been activated (e.g., which has been monitored). There may be provided several voltage balancing units in the system, wherein one voltage balancing unit may be associated with one or more of the energy storage units.

The at least one control and/or processing unit may be configured to, for each voltage balancing unit, determine a curve (or function) of the time during which the at least one voltage balancing unit is or has been activated as a function of time, and provide the indication that the at least one of the energy storage units with which the voltage balancing unit is associated requires maintenance or replacement based on at least one of a slope of the curve at a point on the curve, and a shape of the curve. The curve may for example be determined based on interpolation between a plurality of values of the time during which the at least one voltage balancing unit is or has been activated at different points in time or during different periods of time.

Each voltage balancing unit may be switchable between an active state (i.e. a state in which it is activated) and an inactive state (i.e. a state in which it is not activated). The at least one control and/or processing unit could in alternative be referred to as at least one processor. Each or any of the energy storage units could in alternative be referred to as an energy storage cell. Each or any voltage balancing unit could in alternative be referred to as a voltage balancing circuit.

Each or any voltage balancing unit may for example comprise one or more so-called bleeder resistors, or bleeder circuits. The reducing of voltage of the energy storage units as described in the foregoing may for example be carried out by means of the bleeding resistor(s)/circuit(s) of the voltage balancing unit(s). Accordingly, each or any voltage balancing unit may be configured to reduce the voltage of at least one of the energy storage units associated with the voltage balancing unit by means of one or more bleeder resistors or bleeder circuits that may be comprised in the voltage balancing unit. However, it is contemplated that reducing of voltage of the energy storage units as described in the foregoing could, in alternative or in addition, be carried out by way of other means than bleeder resistors or bleeder circuits.

The method according to the second aspect of the present invention may comprise activating the at least one voltage balancing unit or keeping the at least one voltage balancing unit activated if the voltage of at least one of the energy storage unit(s) associated with the at least one voltage balancing unit exceeds the threshold voltage level, and deactivating or not activating the at least one voltage balancing unit if the voltage of none of the energy storage unit(s) associated with the at least one voltage balancing unit exceeds the threshold voltage level.

The method according to the second aspect of the present invention may comprise activating the at least one voltage balancing unit or keeping the at least one voltage balancing unit activated if the voltage of at least one of the energy storage unit(s) associated with the at least one voltage balancing unit exceeds the threshold voltage level, and, if none of the energy storage unit(s) associated with the at least one voltage balancing unit has a voltage exceeding the threshold voltage level: keeping the at least one voltage balancing unit activated or activating the at least one voltage balancing unit if the voltage of at least one of the energy storage unit(s) associated with the at least one balancing unit is within a selected voltage range below the threshold voltage level, and otherwise deactivating or not activating the at least one voltage balancing unit.

According to a third aspect of the present invention, a computer program is provided. The computer program comprises instructions, which when executed by one or more processors comprised in or constituting a control and/or processing unit, cause the control and/or processing unit to perform a method according to the second aspect of the present invention.

According to a fourth aspect of the present invention, a processor-readable medium is provided. The processor-readable medium has a computer program loaded thereon, wherein the computer program comprises instructions, which, when executed by one or more processors comprised in or constituting a control and/or processing unit, cause the control and/or processing unit to perform a method according to the second aspect of the present invention.

Each or any of the control and/or processing unit(s) may for example include or be constituted by any suitable central processing unit (CPU), microcontroller, digital signal processor (DSP), Application Specific Integrated Circuit (ASIC), Field Programmable Gate Array (FPGA), etc., or any combination thereof. Each or any of the control and/or processing unit(s) may optionally be capable of executing software instructions stored in a computer program product e.g. in the form of a memory. The memory may for example be any combination of read and write memory (RAM) and read only memory (ROM). The memory may comprise persistent storage, which for example can be a magnetic memory, an optical memory, a solid-state memory or a remotely mounted memory, or any combination thereof.

Each or any of the one or more processors may for example comprise a CPU, a microcontroller, a DSP, an ASIC, an FPGA, etc., or any combination thereof.

The processor-readable medium may for example include a Digital Versatile Disc (DVD) or a floppy disk or any other suitable type of processor-readable means or processor-readable (digital) medium, such as, but not limited to, a memory such as, for example, nonvolatile memory, a hard disk drive, a Compact Disc (CD), a Flash memory, magnetic tape, a Universal Serial Bus (USB) memory device, a Zip drive, etc.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the present invention will be described below with reference to the accompanying drawings.

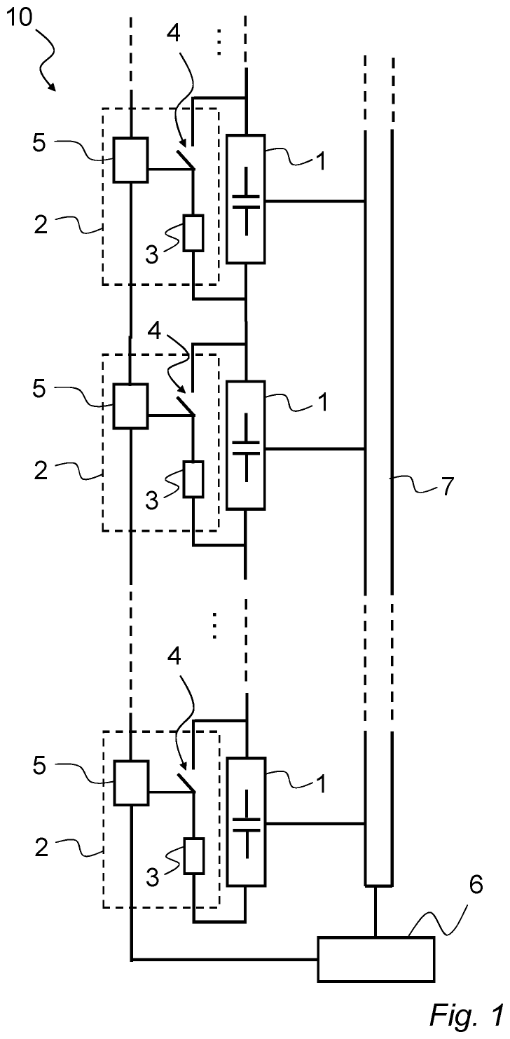

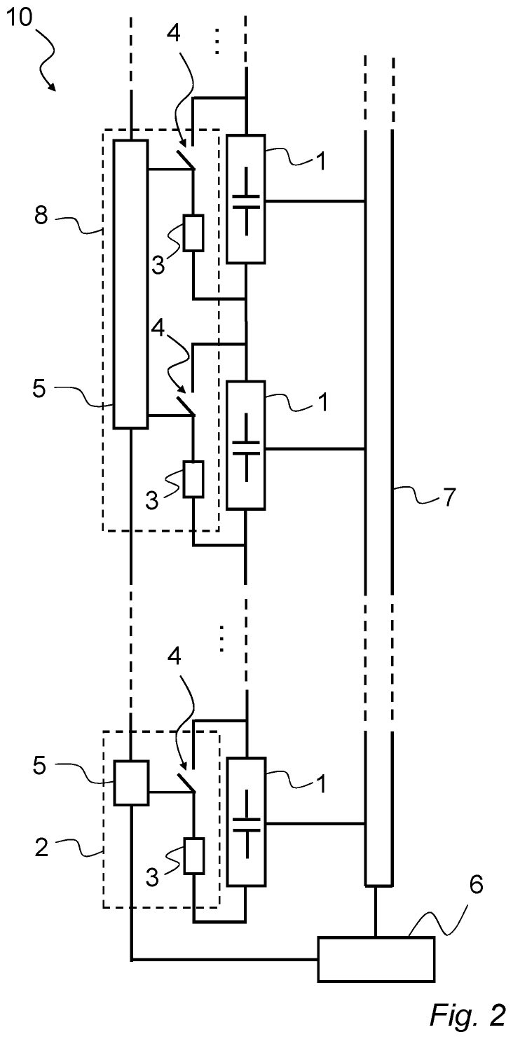

Each of FIGS. 1 and 2 is a schematic view of a system according to an embodiment of the present invention.

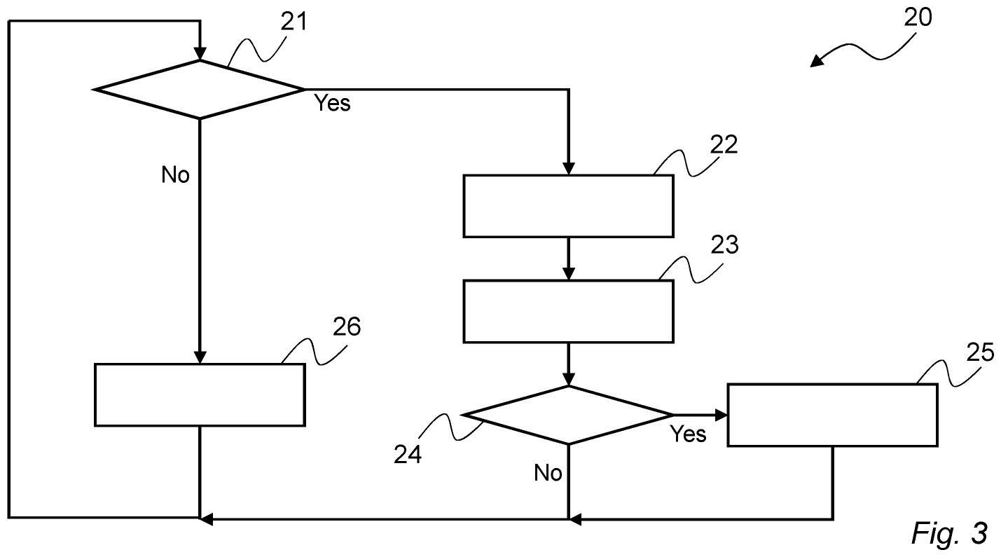

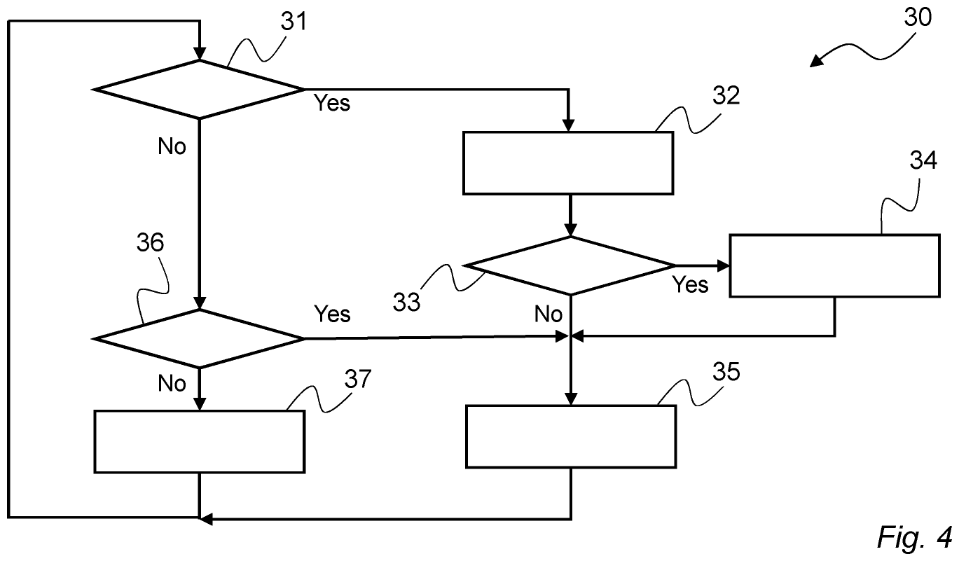

Each of FIGS. 3 and 4 is a schematic flowchart illustrating a method according to an embodiment of the present invention.

All the figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments are provided by way of example so that this disclosure will convey the scope of the present invention to those skilled in the art.

FIG. 1 is a schematic view of system 10 according to an embodiment of the present invention. The system 10 comprises a plurality of energy storage units 1. Each energy storage unit 1 is capable of selectively being charged with electrical energy supplied to the energy storage unit 1 and to discharge electrical energy stored in the energy storage unit 1. Accordingly, the energy storage units 1 could be referred to as electrical energy storage units. It is to be understood that the number of energy storage units 1 illustrated in FIG. 1 is exemplifying, and that the system 10 could include fewer or more energy storage units than illustrated in FIG. 1. The system 10 could in principle include any number of energy storage units, such as tens or hundreds of energy storage units or even more.

As illustrated in FIG. 1, the plurality of energy storage units 1 may be connected in series. A series connection of energy storage units as illustrated in FIG. 1 may be referred to as a string of energy storage units. However, it is to be understood that the plurality of energy storage units 1 could be interconnected in some other way.

As indicated by the markings on the energy storage units 1 in FIG. 1, each or any of the energy storage units 1 may comprise a capacitor (or several capacitors). The capacitor(s) may for example comprise one or more so-called supercapacitors, which may also be referred to as ultracapacitors. However, it is to be understood that the energy storage units must not necessarily comprise capacitors, and that another or other types of energy storage unit may be contemplated. For example, in alternative or in addition, each or any of the energy storage units 1 may comprise one or more batteries.

The system 10 comprises at least one sensing unit, schematically indicated in FIG. 1 at 7. The at least one sensing unit 7 is configured to sense (e.g., at least) a voltage of each of the energy storage units 1. For example, the at least one sensing unit 7 may be configured to, for each of the energy storage units 1, sense a voltage across any capacitor and/or battery of the energy storage unit 1. The at least one sensing unit 7 may comprise one or more sub-units, where each sub-unit may be configured to sense a voltage of one or more of the energy storage units 1. For example, there could be an equal number of energy storage units and sub-units in the system 10, where each sub-unit may be configured to sense a voltage of a respective one of the energy storage units. Possibly, the at least one sensing unit 7 could be configured to sense one or more electrical parameters of the electrical energy storage units 1 other than voltages thereof.

Each energy storage unit 1 may be associated with a threshold voltage level. The threshold voltage level may be fixed or may vary. For example, for each energy storage unit 1, the threshold voltage may vary, and may comprise or consist of a difference between the voltage of the energy storage unit 1 and an average voltage of the voltages of the energy storage units 1 (e.g., an average voltage of the voltages of all of the energy storage units 1). According to another example, for each energy storage unit 1, the threshold voltage may be fixed, and may comprise or consist of an upper voltage limit of the voltage of the energy storage unit 1. The upper voltage limit of the voltage of the energy storage unit 1 may for example be a nominal voltage level set such that a satisfactory functioning of the energy storage unit 1 can only be expected, or a premature aging of the energy storage unit 1 is not expected to occur, when the voltage of the energy storage unit 1 does not exceed the nominal voltage level. The upper voltage limit of the voltage of the energy storage unit 1 may for example be set or provided by a supplier or manufacturer of the energy storage unit 1.

In accordance with the embodiment of the present invention illustrated in FIG. 1, the system 10 comprises a plurality of voltage balancing units 2, wherein each voltage balancing unit 2 is associated with a respective one of the energy storage units 1. It is to be understood that the number of voltage balancing units 2 illustrated in FIG. 1 is exemplifying, and that the system 10 may comprise fewer or more voltage balancing units 2 than illustrated in FIG. 1.

In general, the system 10 may comprise at least one voltage balancing unit, with each voltage balancing unit being associated with at least one of the energy storage units 1. The at least one voltage balancing unit may be connected to the energy storage units 1 and when activated is configured to, on a condition that the voltage of at least one of the energy storage units 1 associated with the at least one voltage balancing unit exceeds the threshold voltage level, reduce the voltage of at least the one(s) of the energy storage units 1 whose voltage exceeds the threshold voltage level so as to become equal to or smaller than the threshold voltage level.

According to the embodiment of the present invention illustrated in FIG. 1, each voltage balancing unit 2 is, when activated, configured to, on a condition that the voltage of the energy storage unit 1 associated with the voltage balancing unit 2 exceeds the threshold voltage level (of that energy storage unit 2), reduce the voltage of the energy storage unit 1 so as to become equal to or smaller than the threshold voltage level.

The reducing of voltage of the energy storage units 1 may for example be carried out by means of bleeding resistor(s)/circuit(s) of the voltage balancing unit(s) 2. For example, and further according to the embodiment of the present invention illustrated in FIG. 1, each voltage balancing unit 2 may comprise a switch 4, a bleeder resistor 3 and a control unit 5. As illustrated in FIG. 1, the switch 4 and the bleeder resistor 3 may be connected in series, and the series connection of the switch 4 and the bleeder resistor 3 may be connected in parallel to the energy storage unit 1 with which the voltage balancing unit 2 is associated. The control unit 5 may be communicatively coupled with the switch 4, and may be configured to control operation of the switch 4, e.g., so as to selectively control the switch 4 to be switched between an open, or non-conductive, state, in which no or substantially no current is conducted through the switch 4, and a closed, or conductive, state, in which the switch 4 conducts current therethrough. Although a wired communicative coupling between the control unit 5 and the switch 4 for each of the voltage balancing units 2 is indicated in FIG. 1, it is to be understood that the control unit 5 and the switch 4 for each or any of the voltage balancing units 2 may be communicatively coupled using any wired and/or wireless communication means. It is to be understood that reducing of voltage of the energy storage units 1 as described in the foregoing could, in alternative or in addition, be carried out by way of other means than bleeder resistors or bleeder circuits.

The system 10 comprises a control and/or processing unit 6. The control and/or processing unit 6 could be referred to as an energy storage management unit. The system 10 could comprise more than one control and/or processing unit. In general, the control and/or processing unit 6 may be configured to, if the at least one voltage balancing unit is activated and the voltage of at least one of the energy storage unit(s) 1 associated with the at least one voltage balancing unit exceeds the threshold voltage level, monitor an amount of time during which the at least one voltage balancing unit is or has been activated. The monitoring may for example be carried out by integrating or summing the amount of time during which the at least one voltage balancing unit is or has been activated.

According to the embodiment of the present invention illustrated in FIG. 1, the control and/or processing unit 6 is configured to, for each of the voltage balancing units 2, if the voltage balancing unit 2 is activated and the voltage of the energy storage unit 1 associated with the voltage balancing unit 2 exceeds the threshold voltage level (of that energy storage unit 2), monitor an amount of time during which the voltage balancing unit 2 is or has been activated.

In general, the control and/or processing unit 6 may be configured to, for each voltage balancing unit 2, provide an indication that the at least one of the energy storage units with which the voltage balancing unit 2 is associated requires maintenance or replacement based at least on a determination that the amount of time during which the voltage balancing 2 unit has been activated exceeds a threshold amount of time.

In accordance with the embodiment of the present invention illustrated in FIG. 1, each voltage balancing unit 2 is associated with a respective one of the energy storage units 1. The control and/or processing unit 6 may be configured to, for each voltage balancing unit 2, provide an indication that the energy storage unit 1 with which the voltage balancing unit 2 is associated requires maintenance or replacement based at least on a determination that the amount of time during which the voltage balancing unit 2 has been activated exceeds a threshold amount of time. As described in the foregoing, the threshold amount of time may be a fixed period of time. However, that it is not required, and the threshold amount of time may not be a fixed period of time.

The at least one sensing unit 7 may be communicatively coupled with the control and/or processing unit 6. Although a wired communicative coupling between the at least one sensing unit 7 and the control and/or processing unit 6 is indicated in FIG. 1, it is to be understood that the at least one sensing unit 7 and the control and/or processing unit 6 may be communicatively coupled using any wired and/or wireless communication means.

Possibly, the control units 5 of the voltage balancing units 2 may be omitted. In that case, the switches 4 of the voltage balancing units 2 may be communicatively coupled (e.g., directly communicatively coupled) with the control and/or processing unit 6, and the control and/or processing unit 6 may be configured to control operation of the switches 4 (e.g., individually).

As mentioned, the control and/or processing unit 6 may be configured to monitor an amount of time during which the at least one voltage balancing unit is or has been activated, if the voltage of at least one of the energy storage unit(s) 1 associated with the at least one voltage balancing unit exceeds the threshold voltage level, and if the at least one voltage balancing unit is activated.

According to one control scheme, the control and/or processing unit 6 may in general be configured to activate the at least one voltage balancing unit or keep the at least one voltage balancing unit activated if the voltage of at least one of the energy storage unit(s) 1 associated with the at least one voltage balancing unit exceeds the threshold voltage level, and deactivate or not activate the at least one voltage balancing unit if the voltage of none of the energy storage unit(s) 1 associated with the at least one voltage balancing unit exceeds the threshold voltage level. In accordance with the embodiment of the present invention illustrated in FIG. 1, the control and/or processing unit 6 may be configured to, for each voltage balancing unit 2, activate the voltage balancing unit 2 or keep the voltage balancing unit 2 activated if the voltage of the energy storage unit 1 associated with the voltage balancing unit 2 exceeds the threshold voltage level, and deactivate or not activate the voltage balancing unit 2 if the voltage of the energy storage unit 1 associated with the voltage balancing unit 2 does not exceed the threshold voltage level. This control scheme will be described further in the following with reference to FIG. 3.

According to another control scheme, the control and/or processing unit 6 may in general be configured to activate the at least one voltage balancing unit or keep the at least one voltage balancing unit activated if the voltage of at least one of the energy storage unit(s) 1 associated with the at least one voltage balancing unit exceeds the threshold voltage level. The control and/or processing unit 6 may in general be further configured to, if none of the energy storage unit(s) 1 associated with the at least one voltage balancing unit has a voltage exceeding the threshold voltage level: activate the at least one voltage balancing unit if the voltage of at least one of the energy storage unit(s) 1 associated with the at least one balancing unit is within a selected voltage range below the threshold voltage level (e.g., within a selected voltage range immediately below the threshold voltage level) and otherwise not activate the at least one voltage balancing unit. In accordance with the embodiment of the present invention illustrated in FIG. 1, the control and/or processing unit 6 may be configured to, for each voltage balancing unit 2, activate the at least one voltage balancing unit or keep the at least one voltage balancing unit activated if the voltage of at least one of the energy storage unit(s) 1 associated with the at least one voltage balancing unit exceeds the threshold voltage level. The control and/or processing unit 6 may be further configured to, for each voltage balancing unit 2, if the energy storage unit 1 associated with the voltage balancing unit 2 has a voltage not exceeding the threshold voltage level: activate the voltage balancing unit 2 if the voltage of at least one of the energy storage unit 1 associated with the voltage balancing unit 2 is within a selected voltage range below the threshold voltage level and otherwise not activate the voltage balancing unit 2. This control scheme will be described further in the following with reference to FIG. 4.

As described in the foregoing, in accordance with the embodiment of the present invention illustrated in FIG. 1, each voltage balancing unit 2 is associated with a respective one of the energy storage units 1. However, it is not required that a voltage balancing unit 2 is only associated with one energy storage unit 1. Possibly, one voltage balancing unit 2 may be associated with several energy storage units 1. An example of this will be described in the following with reference to FIG. 2. In general, one of the voltage balancing unit(s) may be associated with a set of energy storage units 1 including at least two of the plurality of energy storage units 1. The one of the voltage balancing unit(s) may be configured to, when activated, and on a condition that the voltage of at least one of the energy storage units 1 in the set of energy storage units 1 exceeds the threshold voltage level, reduce the voltage of the energy storage unit(s) 1 in the set of energy storage units 1 whose voltage exceeds the threshold voltage level so as to become equal to or smaller than the threshold voltage level. The control and/or processing unit 6 may be configured to, if the one of the voltage balancing unit(s) is activated and the voltage of at least one of the energy storage units 1 in the set of energy storage units 1 exceeds the threshold voltage level, monitor an amount of time during which the one of the voltage balancing unit(s) is or has been activated. Further, the control and/or processing unit 6 may be configured to provide (e.g., generate) an indication (e.g., a signal) that the energy storage units 1 in the set of energy storage units 1 each requires replacement based at least on a determination that the amount of time during which the one of the voltage balancing unit(s) has been activated exceeds a threshold amount of time.

FIG. 2 is a schematic view of system 10 according to an embodiment of the present invention. The system 10 illustrated in FIG. 2 is similar to the system 10 illustrated in FIG. 1, and the same reference numerals in FIGS. 1 and 2 denote the same or similar components, having the same or similar function. However, in contrast to system 10 illustrated in FIG. 1, the system 10 illustrated in FIG. 2 comprises a voltage balancing unit 8 that is associated with several energy storage units 1. According to the embodiment of the present invention illustrated in FIG. 2, the voltage balancing unit 8 is associated with a set of energy storage units 1 that includes two of the energy storage units 1. However, the voltage balancing unit 8 could be associated with in principle any number of energy storage units 1 that may be included in the system 10. Thus, the set of energy storage units 1 could in principle include any number of energy storage units 1 that may be included in the system 10. The system 10 illustrated in FIG. 2 may comprise at least three energy storage units 1.

In accordance with the embodiment of the present invention illustrated in FIG. 2, the voltage balancing unit 8 is configured to, when activated, and on a condition that the voltage of at least one of the energy storage units 1 in the set of energy storage units 1 exceeds the threshold voltage level, reduce the voltage of the energy storage unit(s) 1 in the set of energy storage units 1 whose voltage exceeds the threshold voltage level so as to become equal to or smaller than the threshold voltage level. The control and/or processing unit 6 is configured to, if the voltage balancing unit 8 is activated and the voltage of at least one of the energy storage units 1 in the set of energy storage units 1 exceeds the threshold voltage level, monitor an amount of time during which the voltage balancing unit 8 is or has been activated. The control and/or processing unit 6 may be configured to provide an indication that the energy storage units 1 in the set of energy storage units 1 each requires replacement based at least on the amount of time during which the voltage balancing unit 8 has been activated. For example, the control and/or processing unit 6 may be configured to provide an indication that the energy storage units 1 in the set of energy storage units 1 each requires replacement based at least on a determination that the amount of time during which the voltage balancing unit 8 has been activated exceeds a threshold amount of time.

FIG. 3 is a schematic flowchart illustrating a method 20 in a system according to an embodiment of the present invention. FIG. 4 is a schematic flowchart illustrating a method 30 in a system according to another embodiment of the present invention. In both the method 20 and the method 30, illustrated in FIGS. 3 and 4, respectively, the system comprises a plurality of energy storage units. Each energy storage unit is capable of selectively being charged with electrical energy supplied to the energy storage unit and to discharge electrical energy stored in the energy storage unit. Each energy storage unit is associated with a threshold voltage level. The system further comprises at least one voltage balancing unit. Each voltage balancing unit is associated with at least one of the energy storage units. The at least one voltage balancing unit is connected to the energy storage units. The at least one voltage balancing unit is when activated configured to, on a condition that the voltage of at least one of the energy storage units associated with the at least one voltage balancing unit exceeds the threshold voltage level, reduce the voltage of at least the one(s) of the energy storage units whose voltage exceeds the threshold voltage level so as to become equal to or smaller than the threshold voltage level.

With reference to the method 20 illustrated in FIG. 3, it is checked, at 21, whether the voltage of at least one of the energy storage unit(s) associated with the at least one voltage balancing unit exceeds the threshold voltage level. If the voltage of at least one of the energy storage unit(s) associated with the at least one voltage balancing unit exceeds the threshold voltage level, then the method proceeds to 22, at which the at least one voltage balancing unit is kept activated (if presently activated) or activated (if presently not activated). The at least one voltage balancing unit reduces the voltage of at least the one(s) of the energy storage units whose voltage exceeds the threshold voltage level so as to become equal to or smaller than the threshold voltage level. Subsequently, at 23, an amount of time during which the at least one voltage balancing unit is or has been activated is monitored.

The method 20 further comprises, at 24, for each voltage balancing unit, checking whether the amount of time during which the voltage balancing unit has been activated exceeds a threshold amount of time.

If that is the case for any voltage balancing unit, then, at 25, for each of those voltage balancing unit(s) an indication that the at least one of the energy storage units with which the voltage balancing unit is associated requires maintenance or replacement is provided, based at least on the determination that the amount of time during which the voltage balancing unit has been activated exceeds the threshold amount of time.

If the amount of time during which the voltage balancing unit has been activated does not exceed a threshold amount of time for any voltage balancing unit, then the method 20 returns to 21.

If it is determined at 21 that the voltage of none of the energy storage unit(s) associated with the at least one voltage balancing unit exceeds the threshold voltage level, then, at 26, the at least one voltage balancing unit is deactivated (if presently activated) or not activated (if presently not activated). Then the method 20 returns to 21.

With reference to the method 30 illustrated in FIG. 4, it is checked, at 31, whether the voltage of at least one of the energy storage unit(s) associated with the at least one voltage balancing unit exceeds the threshold voltage level. If the voltage of at least one of the energy storage unit(s) associated with the at least one voltage balancing unit exceeds the threshold voltage level, then the method proceeds to 32, at which, if the at least one voltage balancing unit is activated, an amount of time during which the at least one voltage balancing unit is or has been activated is monitored. The at least one voltage balancing unit reduces the voltage of at least the one(s) of the energy storage units whose voltage exceeds the threshold voltage level so as to become equal to or smaller than the threshold voltage level.

The method 30 further comprises, at 33, for each voltage balancing unit, checking whether the amount of time during which the voltage balancing unit has been activated exceeds a threshold amount of time.

If that is the case for any voltage balancing unit, then, at 34, for each of those voltage balancing unit(s), an indication that the at least one of the energy storage units with which the voltage balancing unit is associated requires maintenance or replacement is provided based at least on the determination that the amount of time during which the voltage balancing unit has been activated exceeds the threshold amount of time. The method 30 then proceeds to 35, at which the at least one voltage balancing unit is activated (if not presently activated) or kept activated (if present activated). Based on the above, this is carried out if the voltage of at least one of the energy storage unit(s) associated with the at least one voltage balancing unit exceeds the threshold voltage level, which is checked at 31.

If, based on the check at 33, it is determined that for no voltage balancing unit, the amount of time during which the voltage balancing unit has been activated exceeds a threshold amount of time, the method 30 proceeds to 35 without carrying out operation 34.

If, based on the check at 31, it is determined that none of the energy storage unit(s) associated with the at least one voltage balancing unit has a voltage exceeding the threshold voltage level, the method 30 proceeds to 36, at which it is checked whether the voltage of at least one of the energy storage unit(s) associated with the at least one balancing unit is within a selected voltage range below the threshold voltage level. If that is the case, then the method 30 proceeds to 35, at which, as mentioned in the foregoing, the at least one voltage balancing unit is activated (if not presently activated) or kept activated (if presently activated). Then the method 30 returns to 31.

If, based on the check at 36, it is determined that none of the energy storage unit(s) associated with the at least one balancing unit has a voltage within a selected voltage range below the threshold voltage level, then the method 30 proceeds to 37, at which the at least one voltage balancing unit is deactivated (if presently activated) or not activated (if presently not activated). Then the method 30 returns to 31.

In conclusion, a system is disclosed, comprising a plurality of energy storage units and at least one voltage balancing unit. Each voltage balancing unit is associated with at least one of the energy storage units. The at least one voltage balancing unit is connected to the energy storage units and when activated is configured to, on a condition that the voltage of at least one of the energy storage units associated with the at least one voltage balancing unit exceeds a threshold voltage level, reduce the voltage of at least the one(s) of the energy storage units whose voltage exceeds the threshold voltage level so as to become equal to or smaller than the threshold voltage level. The system comprises at least one control and/or processing unit configured to, if the at least one voltage balancing unit is activated and the voltage of at least one of the energy storage unit(s) associated with the at least one voltage balancing unit exceeds the threshold voltage level, monitor an amount of time during which the at least one voltage balancing unit is or has been activated.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A system comprising:
a plurality of energy storage units each energy storage unit being capable of selectively being charged with electrical energy supplied to the energy storage unit and to discharge electrical energy stored in the energy storage unit, each energy storage unit being associated with a threshold voltage level;
at least one sensing unit configured to sense a voltage of each of the energy storage units;
at least one voltage balancing unit, each voltage balancing unit being associated with at least one of the energy storage units, the at least one voltage balancing unit being connected to the energy storage units and when activated is configured to, on a condition that the voltage of at least one of the energy storage units associated with the at least one voltage balancing unit exceeds the threshold voltage level, reduce the voltage of at least the one(s) of the energy storage units having a voltage that exceeds the threshold voltage level so as to become equal to or smaller than the threshold voltage level; and
at least one control and/or processing unit configured to, if the at least one voltage balancing unit is activated and the voltage of at least one of the plurality of energy storage unit(s) associated with the at least one voltage balancing unit exceeds the threshold voltage level, monitor an amount of time during which the at least one voltage balancing unit is or has been activated.

2. A system according to claim 1, wherein the at least one control and/or processing unit is configured to, for each voltage balancing unit, provide an indication that the at least one of the energy storage units with which the voltage balancing unit is associated requires maintenance or replacement based at least on the amount of time during which the voltage balancing unit has been activated.

3. A system according to claim 2, wherein the at least one control and/or processing unit is configured to, for each voltage balancing unit, provide the indication based on at least one of:
a determination that the amount of time during which the voltage balancing unit has been activated exceeds a threshold amount of time; and
a comparison between the amount of time during which the voltage balancing unit has been activated and the amount of time during which at least one other voltage balancing unit has been activated.

4. A system according to claim 2, wherein the at least one control and/or processing unit is configured to, for each voltage balancing unit:
determine a difference between the amount of time during which the voltage balancing unit has been activated and the amount of time during which at least one other voltage balancing unit has been activated;
determine whether the difference exceeds a threshold difference; and
provide the indication based on the determination whether the difference exceeds the threshold difference.

5. A system according to claim 2, wherein the at least one control and/or processing unit is configured to, for each voltage balancing unit, determine a curve of the time during which the at least one voltage balancing unit is or has been activated as a function of time, and provide the indication based on at least one of:
a slope of the curve at a point on the curve; and
a shape of the curve.

6. A system according to claim 1, wherein, for each energy storage unit, the threshold voltage can vary and comprises or consists of a difference between the voltage of the energy storage unit and an average voltage of the voltages of the energy storage units.

7. A system according to claim 1, wherein, for each energy storage unit, the threshold voltage is fixed and comprises or consists of an upper voltage limit of the voltage of the energy storage unit.

8. A system according to claim 1, wherein the at least one control and/or processing unit is configured to activate the at least one voltage balancing unit or keep the at least one voltage balancing unit activated if the voltage of at least one of the energy storage unit(s) associated with the at least one voltage balancing unit exceeds the threshold voltage level, and deactivate or not activate the at least one voltage balancing unit if the voltage of none of the energy storage unit(s) associated with the at least one voltage balancing unit exceeds the threshold voltage level.

9. A system according to claim 1, wherein the at least one control and/or processing unit is configured to activate the at least one voltage balancing unit or keep the at least one voltage balancing unit activated if the voltage of at least one of the energy storage unit(s) associated with the at least one voltage balancing unit exceeds the threshold voltage level, and, if none of the energy storage unit(s) associated with the at least one voltage balancing unit has a voltage exceeding the threshold voltage level: keep the at least one voltage balancing unit activated or activate the at least one voltage balancing unit if the voltage of at least one of the energy storage unit(s) associated with the at least one voltage balancing unit is within a selected voltage range below the threshold voltage level and otherwise deactivate or not activate the at least one voltage balancing unit.

10. A system according to claim 1, wherein one of the voltage balancing unit(s) is associated with a set of energy storage units including at least two of the plurality of energy storage units, wherein the one of the voltage balancing unit(s) is, when activated, configured to, on a condition that the voltage of at least one of the energy storage units in the set of energy storage units exceeds the threshold voltage level, reduce the voltage of the energy storage unit(s) in the set of energy storage units having a voltage that exceeds the threshold voltage level so as to become equal to or smaller than the threshold voltage level;
wherein the at least one control and/or processing unit is configured to, if the one of the voltage balancing unit(s) is activated and the voltage of at least one of the energy storage units in the set of energy storage units exceeds the threshold voltage level, monitor an amount of time during which the one of the voltage balancing unit(s) is or has been activated.

11. A system according to claim 10, wherein the at least one control and/or processing unit is configured to provide an indication that the energy storage units in the set of energy storage units each requires replacement based at least on the amount of time during which the one of the voltage balancing unit(s) has been activated.

12. A system according to claim 1, wherein each of the energy storage units comprises one or more of at least one capacitor and at least one battery.

13. A system according to claim 12, wherein the at least one sensing unit is configured to, for each of the energy storage units, sense a voltage across the at least one capacitor and/or the at least one battery of the energy storage unit.

14. A system according to claim 1, wherein the plurality of energy storage units are connected in series.

15. A method in a system, the system comprising a plurality of energy storage units, each energy storage unit being capable of selectively being charged with electrical energy supplied to the energy storage unit and to discharge electrical energy stored in the energy storage unit, each energy storage unit being associated with a threshold voltage level, the system further comprising at least one voltage balancing unit, each voltage balancing unit being associated with at least one of the energy storage units, the at least one voltage balancing unit being connected to the energy storage units and when activated is configured to, on a condition that the voltage of at least one of the energy storage units associated with the at least one voltage balancing unit exceeds the threshold voltage level, reduce the voltage of at least the one(s) of the energy storage units having a voltage that exceeds the threshold voltage level so as to become equal to or smaller than the threshold voltage level, the method comprising:
if the at least one voltage balancing unit is activated and the voltage of at least one of the plurality of the energy storage unit(s) associated with the at least one voltage balancing unit exceeds the threshold voltage level, monitoring an amount of time during which the at least one voltage balancing unit is or has been activated.

16. A method according to claim 15, further comprising:
activating the at least one voltage balancing unit or keeping the at least one voltage balancing unit activated if the voltage of at least one of the energy storage unit(s) associated with the at least one voltage balancing unit exceeds the threshold voltage level; and
deactivating or not activating the at least one voltage balancing unit if the voltage of none of the energy storage unit(s) associated with the at least one voltage balancing unit exceeds the threshold voltage level.

17. A method according to claim 15, further comprising:
activating the at least one voltage balancing unit or keeping the at least one voltage balancing unit activated if the voltage of at least one of the energy storage unit(s) associated with the at least one voltage balancing unit exceeds the threshold voltage level; and
if none of the energy storage unit(s) associated with the at least one voltage balancing unit has a voltage exceeding the threshold voltage level:
keeping the at least one voltage balancing unit activated or activating the at least one voltage balancing unit if the voltage of at least one of the energy storage unit(s) associated with the at least one balancing unit is within a selected voltage range below the threshold voltage level; and
otherwise deactivating or not activating the at least one voltage balancing unit.

18. A computer program comprising instructions, which when executed by one or more processors comprised in a control and/or processing unit, cause the control and/or processing unit to perform the method of claim 15.
